(19) United States
(12) Patent Application Publication
(10) Pub. No.: US 2024/0206655 A1
(43) Pub. Date: Jun. 27, 2024

(54) KNIFE HOLDER DEVICE AND KNIFE

(71) Applicant: Yasuhiro TSUTSUMI, Kumamoto (JP)

(72) Inventor: Yasuhiro TSUTSUMI, Kumamoto (JP)

(21) Appl. No.: 18/596,773

(22) Filed: Mar. 6, 2024

Related U.S. Application Data
(63) Continuation of application No. PCT/JP22/31808, filed on Aug. 24, 2022.

(30) Foreign Application Priority Data
Sep. 14, 2021 (JP) 2021-149183

(51) Int. Cl. A47G 21/14

(52) U.S. Cl. CPC A47G 21/14; A47G 2200/106

(57) ABSTRACT

A knife holder includes magnets attached to the knife holder in a row in one direction, and the knife holder magnetically adheres to a top portion of a spine of a knife when a long side of the knife is oriented horizontally so that the knife holder suspends the entire knife in air. A support body supports the knife holder at a predetermined height position. A separating/holding mechanism is attached to the knife holder and configured to hold the knife in air while separating the top portion of the spine of the knife from the magnetic adhesion surface at a position below the magnetic adhesion surface. Since the spine top portion of the knife is held by magnetic adhesion, the knife can be temporarily placed and taken out by an easy insertion operation requiring little force.

### CROSS-REFERENCE TO RELATED APPLICATIONS

This application is a continuation application of International Patent Application No. PCT/JP2022/031808 filed on Aug. 24, 2022, which claims priority to Japanese Patent Application No. 2021-149183 filed on Sep. 14, 2021, the entire contents of which are incorporated by reference.

### TECHNICAL FIELD

The present invention relates to a knife holder device that holds a knife, and a knife.

### BACKGROUND ART

The present applicant has previously experienced difficulties when cooking, such as simultaneously performing cumbersome tasks like cooking on a stovetop, tasting food, adding seasoning, and stirring food that is cooking on the stovetop. Particularly, while ingredients are being heated or during other similar tasks, knives used for cutting ingredients must be returned to the back of the door under the kitchen sink or to a drawer or other compartment, and this may cause food that is being cooked to overflow or cause a user to accidentally injure their hand or finger. To solve this problem, the present applicant devised the knife holder and knife holder device disclosed in Patent Document 1.

### Cited Documents

### Patent Document

Patent Document 1: JP 6789434 B

### SUMMARY OF INVENTION

### Problem to be Solved by Invention

The device of Patent Document 1 proposes a knife holder in which a knife is magnetically and detachably supported by magnets attached to a holder body, in which the magnets are arranged in a row at a substantially central position of the holder body as viewed from one end of the holder body in a width direction. This configuration proposes a knife holder that can stably accommodate and hold the knife, even if the knife is handled roughly during the cumbersome task of putting away or taking out the knife during cooking. However, in the knife holder and knife holder device of Patent Document 1, strong magnets are used to prevent the knife from falling, which means that a certain degree of strength is required to take out and put away the knife. Thus, storing the knife or taking out the knife from the holder is not entirely stable. Additionally, a top portion of a spine of the knife is likely to slide against a bottom wall of the holder and become scratched due to friction, resulting in bacteria easily adhering to the scratched portion. Thus, there is room for improvement in terms of hygiene. Further, when storing the knife in the holder, there is a risk that the knife may fall because the knife is not inserted to a safe position for holding the knife, or because the knife is inserted too deeply and shifts from the positions of the magnets.

The present invention has been made in light of the above-described problem, and an object of the present invention is to provide a knife holder, a knife holder device, and a knife that can stably store and hold a knife at a certain storage position for safe and hygienic use, even when the knife is frequently stored and taken out during cooking.

### Solution to Problem

To solve the above-described problem, the present invention provides a knife holder 2 including magnets 18 attached to the knife holder 2 in a row in one direction, the knife holder 2 being configured to magnetically adhere to a top portion t of a spine m of a knife 3 when a long side of the knife 3 is oriented horizontally so that the knife holder 2 suspends the entire knife 3 in air; a support body 4 supporting the knife holder 2 at a predetermined height position; and a separating/holding mechanism 5 attached to the knife holder 2 and being configured to hold the knife 3 in air while separating the top portion t of the spine m of the knife 3 from a magnetic adhesion surface WS at a position lower than the magnetic adhesion surface WS.

In this configuration, the separating/holding mechanism 5 May include a guide portion 50 provided at an end portion side of the knife holder 2, the end portion side being an insertion side at which the knife 3 is inserted into the knife holder 2, the guide portion 50 being configured to come into contact with the top portion t of the spine m of the knife at a position at least lower than the magnetic adhesion surface WS of the knife holder 2.

Additionally, the guide portion 50, 61, 62, 71, 72 May be an engaging piece including a portion that comes into contact with the top portion t of the spine of the knife at a position lower than the magnetic adhesion surface WS of the knife holder 2, or a rotating roller body 73 that rotates about a horizontal axis.

Further, at least two of the guide portions 50, 61, 62, 71, 72 May be provided at the end portion side of the knife holder being the insertion side at which the knife 3 is inserted into the knife holder 2 and a side in front of the insertion side, respectively, and each of the guide portions 50, 61, 62, 71, 72 May be the rotating roller body 73 that rotates about a horizontal axis.

Further, the present invention is a knife 3B configured to be magnetically supported by the magnets 18 of the knife holder device 1, 60, 70 described above, in which the knife 3B may include a body d portion of the knife in the vicinity of a bolster 32 of the knife, and a downward-recessed recess 81 formed in the top portion t of the spine of the knife, recessed from the top portion line of the spine of the knife and configured to detachably fit with a contact portion 51 of the guide portion.

### EFFECTS OF THE INVENTION

According to the knife holder, the knife holder device, and the knife of the present invention, the knife can be easily and reliably stored and taken out to/from the holder even when the knife needs to be frequently stored and taken out during cooking, and the top portion of the spine of the knife is less likely to become contaminated with bacteria when the knife is inserted into and removed from the device, making daily knife use simple, hygienic, and even safer.

### BRIEF DESCRIPTION OF DRAWINGS

FIG. 1 is a schematic perspective view of a holder body of a knife holder device according to a first embodiment of the present invention, where a knife to be supported is also illustrated.

FIG. 2 is an enlarged perspective view of a knife holder illustrated in FIG. 1.

FIG. 3 is a front view of the knife holder device in a state where the knife holder in FIG. 1 is attached to a support body.

FIG. 4 is a cross-sectional view illustrating a state where the knife is mounted to the knife holder device in FIG. 2.

FIG. 5 is a cross-sectional view illustrating a state where the knife is mounted to a knife holder according to a second embodiment of the present invention.

FIG. 6 is an enlarged perspective view of a knife holder according to a third embodiment of the present invention.

FIG. 7 is a partially-omitted side view illustrating another embodiment of a knife mounted to the knife holder device according to each embodiment of the present invention.

FIG. 8 is a cross-sectional view illustrating a state where the knife according to the embodiment illustrated in FIG. 7 is mounted to the knife holder device according to the third embodiment illustrated in FIG. 6.

### DESCRIPTION OF EMBODIMENTS

Embodiments of a knife holder device and a knife used in the knife holder device will be described with reference to the appended drawings.

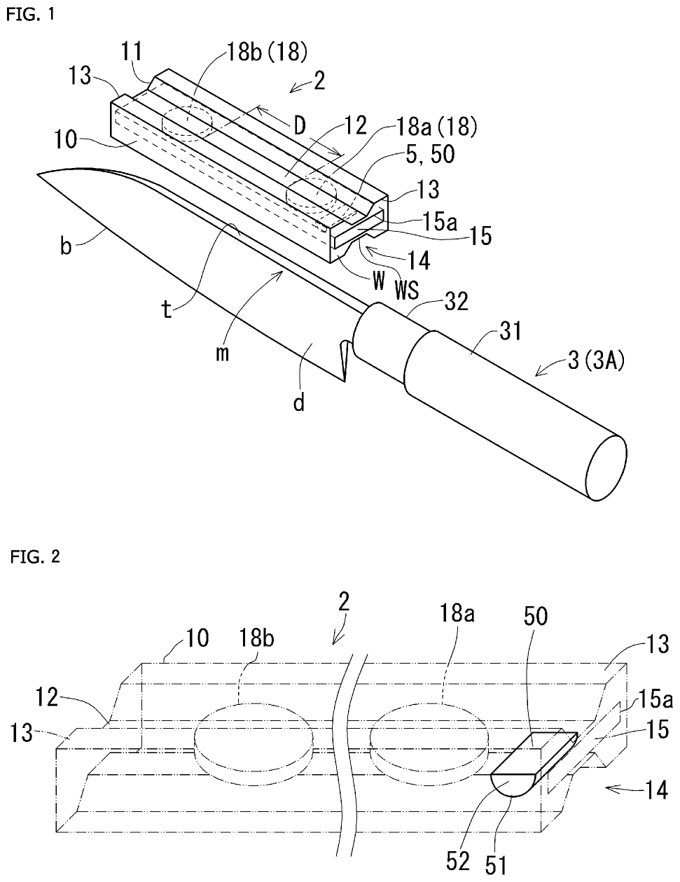

FIGS. 1 to 4 illustrate a schematic configuration of a knife holder device 1 according to a first embodiment of the present invention. FIG. 1 illustrates a knife holder 2 of the knife holder device and a knife 3 (3A) used in the knife holder 2.

As illustrated in FIGS. 1 to 3, the knife holder device 1 according to the first embodiment includes the knife holder 2, a support body 4, and a separating/holding mechanism 5.

The knife holder 2 forms the structural portion of the knife holder device and is a body portion of the device 1 suspending the entire knife. In the embodiment, the knife holder 2 is configured by a thick plate-like body elongated in one direction. In FIG. 1, the knife holder 2 includes a holder body 10, and magnets 18 attached to the holder body 10.

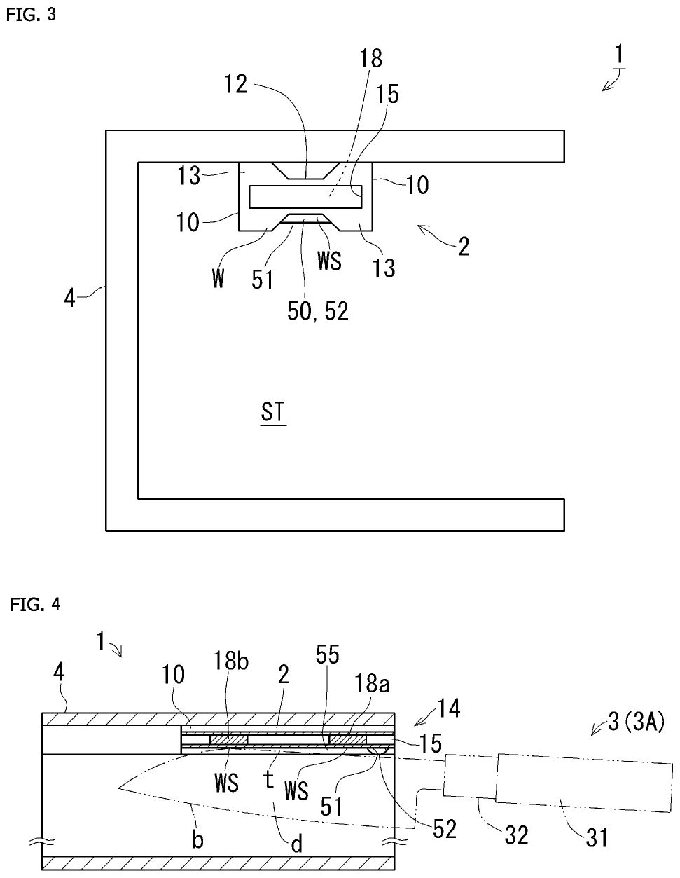

As illustrated, the holder body 10 is configured by a thick plate-like body elongated in one direction. In the holder body 10, central portions of upper and lower plate surfaces of the plate-like body when the plate surfaces are arranged vertically each include a recessed portion 11 recessed in the form of an inverted trapezoidal groove in the longitudinal direction along the entire length of the plate-like body. Accordingly, as illustrated in FIGS. 2 and 3, a portion sandwiched by the top and bottom recessed portions 11 at the central portions having a ferric bell-shape form a thinned portion 12 as viewed from an end face side, and either end side forms an enlarged portion 13. Further, the end face sides of the holder body 10 serve as insertion portions 14 when the knife is inserted and mounted. Note that, the shape of the holder body 10 is not limited to a ferric bell-shape. For example, an upper face side of the holder body 10 May be arc-shaped, expanded into a ridge, or protruded. A top portion of a spine of the knife is suspended by the magnetic force of the magnets. Thus, a space having a thickness greater than the thickness of the knife in a horizontal state with the blade facing down needs to be formed in a bottom face side of the holder body 10.

At a central thickness portion of the ferric bell-shaped holder body 10, as viewed from the end face, a thin plate-like hole 15 elongated in the longitudinal direction of the holder body 10 is formed from one enlarged portion 13 to the other enlarged portion 13 across the thinned portion 12. Thin-plate button-shaped permanent magnets 18 are inserted through and fastened at openings 15a of the thin plate-like holes 15 at the end face side of the holder body.

In the embodiment, the thin-plate button-shaped magnets 18 are arranged inside the thin plate-like holes 15 in a row of two. In this case, the holder body 10 is a thick plate long in one direction, includes the recessed portions 11 recessed in groove shapes in the longitudinal direction along the entire length of the plate-like body at the center portions of the upper and lower plate surfaces, and includes the thin plate-like hole 15 formed further inward at the portion sandwiched between the upper and lower recessed portions 11. Therefore, a bottom wall W of thin-plate hole 15 of the thin-walled portion 12 at the bottom surface of the holder body 10 is formed even thinner to a thickness sufficient to effectively exert magnetic force.

The holder body 10 May be any rigid body capable of suspending a knife, and any material can be selected. For example, hard plastic, light metal, ceramic, a wood/bamboo material, a metal, an alloy, or a composite material can be used.

In FIGS. 1 and 2, the magnet 18 is a magnetic unit configured to magnetically support the top portion t of the spine m of the knife 3 in a detachable manner. The magnets 18 are attached to the holder body 10 and suspend the knife 3 with a blade b of the knife 3 facing down at a lower face side of the holder body 10. For example, the magnets 18 are provided in a row of two or more separated by an interval D and magnetically support the top portion t of the spine m of the knife 3 in a detachable manner. In the embodiment, as the magnets 18, two permanent magnets 18a and 18b are attached separated by the interval D.

In FIGS. 2 and 3, the two magnets 18 inserted into the thin plate-like holes 15 magnetically adhere to the top portion t of the spine m of the knife 3 at magnetic field centers thereof to suspend the knife in a horizontal state, for example. The bottom face of the holder body 10 securely magnetically adheres to the top portion t of the spine m of the knife 3 by means of the permanent magnets 18 in the thin plate-like holes 15 via bottom walls W of the thin plate-like holes 15. Thus, the knife can be securely suspended with the blade of the knife facing down.

In the embodiment, the magnets 18 are disposed at substantially central positions of the holder body 10 in the width direction as viewed from one end side. With this configuration, sufficient clearance is created on either side of a body d of the knife when the magnets magnetically adhere to the top portion t of the spine m of the knife 3 and the knife is suspended with the blade b of the knife facing down, and the knife can be used without the body of the knife coming into contact with surrounding wall surfaces or equipment when the knife is taken out and put back. Note that, reference sign 31 denotes a knife grip, and reference sign 32 denotes a bolster for attaching the knife body to the grip 31.

In the embodiment, as illustrated in FIGS. 2 and 3, the knife holder 2 is fixed to the support body 4, which has a U-shaped plate shape with one end face open. This creates a sufficient lower space ST and thus a sufficient clearance on at least one side when the top portion t of the spine of the knife magnetically adheres to the knife holder 2. Thus, the knife can be reliably held at the set position even when handled roughly.

In FIG. 2, the support body 4 is illustrated as being formed in a U-shaped plate shape with one end face open. However, the support body 4 can be configured as a knife holder device installed in a primary location in a kitchen and using a support stand or a frame that supports the holder body 10. Alternatively, wall portions or equipment in the space in which the knife is generally stored may be used and the support body 4 May be directly attached to an existing wall surface or the equipment itself.

A separating/holding mechanism 5 is a separation/holding unit that separates the knife inserted laterally from the magnetic adhesion surface at a position below the magnetic adhesion surface so that the knife in held in air, and allows the top portion t of the spine m of the knife to be supported in air without contact with the magnetic adhesion surface WS of the knife holder when the top portion t of the spine m of the knife is magnetically adhered and supported.

In the embodiment, the separating/holding mechanism 5 is attached to the knife holder 2. More specifically, the separating/holding mechanism 5 includes a guide portion 50 provided to a portion of the bottom wall W of the holder body 10. The guide portion 50 includes a contact portion 51 configured to come into contact with the top portion t of the spine m of the knife 3 at a position lower than the magnetic adhesion surface WS of the knife holder 2. The magnetic adhesion surface WS of the knife holder 2 incudes a bottom face portion of the bottom wall W. More specifically, in the embodiment, the guide portion 50 is configured by a semicylindrical pin 52 serving as an engaging piece, as illustrated in FIG. 2. In the embodiment, the semicylindrical pin 52 is fixed to a lower face side of the holder body 10 by a screw, fitting, or another fixing method with an arc portion of the pin 52 facing downward and the longitudinal direction of the pin 52 aligned with a direction intersecting or substantially orthogonal to the longitudinal direction of the holder body 10. Additionally, when mounting the knife to the knife holder 2, a portion of the top portion t of the spine of the knife comes into contact with the arc portion of the semicylindrical pin.

Further, the guide portion 50 is provided at an end portion side of the knife holder, which serves as a side on which the knife is inserted into the knife holder 2. More specifically, the guide portion 50 is provided in the vicinity of the insertion portion 14. Accordingly, the guide portion 50 guides insertion when the knife 3 is inserted into the lower face side of the knife holder 2 and, after insertion is complete, magnetically holds the knife 3 in air at a lower position at which the top portion t of the spine m of the knife is separated from the magnetic adhesion surface WS of the holder body 10.

Specifically, the pin 52 includes the contact portion 51 configured to come into contact with the top portion t of the spine m of the knife 3 at an insertion position further in front than the first permanent magnet 18a of the two button-shaped magnets disposed at a distal end side and a proximal side in the thin plate-like holes 15, and a position lower than the adhesion surface WS of the magnet 18. With this configuration, the knife is inserted from below the contact portion 51 of the guide portion 50 and, when the knife is lifted upward toward the bottom face side of the knife holder 2 near the grip 31 of the knife, the knife magnetically adheres at the bottom surface of the knife holder by the magnets 18 at a position closer to the distal end than the center along the length of the knife, as illustrated in FIG. 4. Additionally, the held end of the knife comes into contact with the contact portion 51 of the guide portion 50 such that the knife is held in air in a state where the distal end is pointing upward and the held end is pointing downward. In this state, an elongated, triangular tapered clearance 55 is formed between the top portion t of the spine of the knife and the magnetic adhesion surface WS.

The knife 3 is caused to magnetically adhere to the knife holder 2 by being lifted from the lower position of the knife holder 2 toward the bottom wall of the knife holder 2, so that the knife can be mounted to the holder and suspended with a light operation without inserting the knife into the knife holder 2 with more force than necessary.

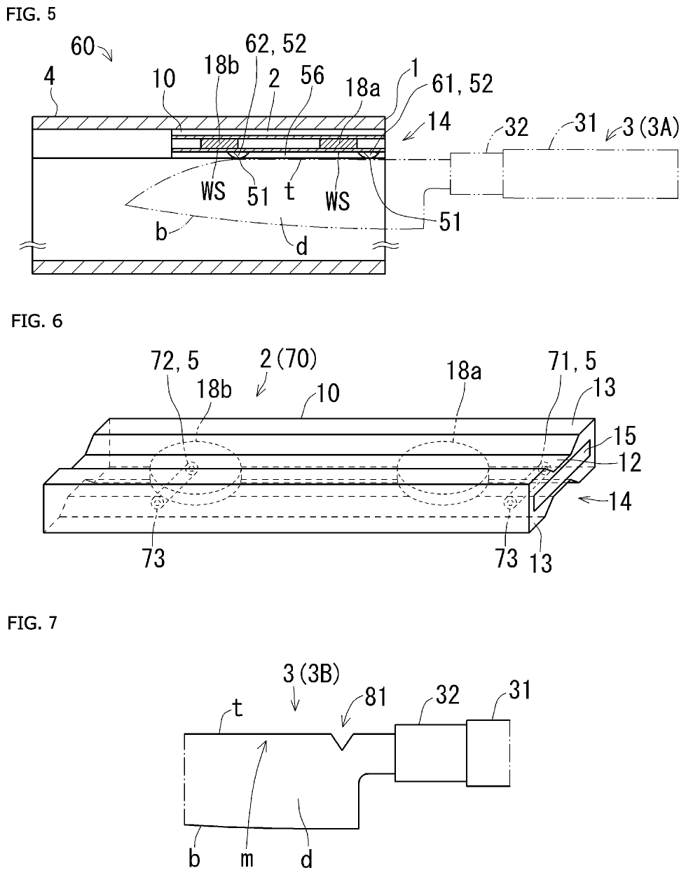

Next, a knife holder device 60 according to a second embodiment of the present invention will be described with reference to FIG. 5. In the knife holder device 60 according to the second embodiment, the guide portion of the separating/holding mechanism 5 includes a first guide portion 61 provided in the vicinity of an insertion position further in front than the first permanent magnet 18a and a second guide portion 62 disposed at a position separated frontward of the guide portion 61. The first and second guide portions each include the contact portion 51 configured to come into contact with the top portion t of the spine m of the knife 3 at a position lower than the magnetic adhesion surfaces WS of the magnets 18a and 18b . Similar to the first embodiment, in this embodiment, the first and second guide portions 61 and 62 are each configured by the semicylindrical pin 52 serving as an engaging piece and are fixed to the lower face side of the holder body 10 with the arc portion facing downward and the longitudinal direction aligned with a direction intersecting or substantially orthogonal to the longitudinal direction of the holder body 10.

In the device 60 according to the second embodiment, as illustrated in FIG. 5, the first and second guide portions 61 and 62 magnetically support a linear portion of the top portion of the spine m of the knife 3 in air in a substantially horizontal state, with the knife 3 mounted to a lower face of the knife holder 2. In this state, the thin plate-like clearance 56 having a constant thickness is formed between the top portion t of the spine of the knife and the magnetic adhesion surfaces WS. Accordingly, the only portions in contact with the top portion of the spine m of the knife are the contact portions 51 of the first and second guide portions 61 and 62, which substantially eliminates contact with the top portion of the spine of the knife, greatly reduces contact scratches at portions such as the top portion of the spine of the knife, and allows the knife spine top portion, which can be a breeding ground for bacteria, to be hygienically held and for food preparation to be performed safely.

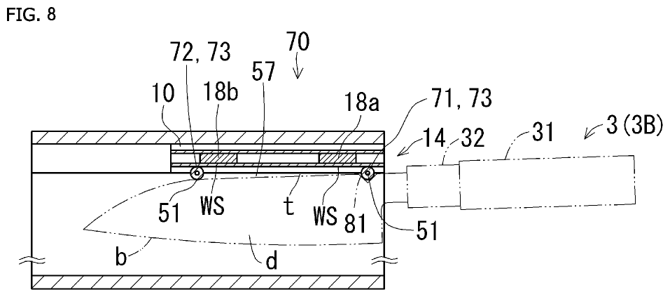

Next, a knife holder device 70 according to a third embodiment of the present invention will be described with reference to FIGS. 6 and 8. In the knife holder device 70 according to the third embodiment, the guide portion of the separating/holding mechanism 5 includes a first guide portion 71 provided in the vicinity of an insertion position further in front than the first permanent magnet 18a and a second guide portion 72 disposed at a position separated frontward of the first guide portion 71. The first and second guide portions each include a contact portion 51 configured to come into contact with the top portion t of the spine m of the knife 3 at a position lower than the magnetic adhesion surfaces WS of the magnets 18a and 18b .

In this embodiment, the guide portions 71 and 72 are each configured by a rotating roller body 73 that rotates about a horizontal axis. The guide portion 51 of the rotating roller body 73 corresponds to a tangent position of the horizontal tangent line of the roller body.

In the third embodiment, the roller body is attached to the holder body 10. The roller body rotates freely with its center of rotation in a direction that intersects or is orthogonal to the longitudinal direction of the holder body 10.

Even with the device 70 according to the third embodiment, the first and second guide portions 71 and 72 hold the knife 3 in air, with the top portion t of the spine m of the knife 3 separated from the magnetic adhesion surface WS at a position lower than the magnetic adhesion surface WS.

The knife 3 (3B) is disposed below the magnetic adhesion surface WS at a space from the magnetic adhesion surface WS at the front and rear such that the entire knife 3 (3B) is held in air by the guide portions 71 and 72 including the contact portions 51 at a position lower than the magnetic adhesion surface WS, separated from the magnetic adhesion surface WS by a clearance 57. Accordingly, the top portion t of the spine of the knife does not directly come into contact with the bottom wall of the knife holder 2, and damage to the knife can be prevented. Note that, as in the second embodiment, as the in-air supported posture of the knife, the knife may be magnetically supported in the air such that the linear portion of the spine top portion t of the mounted knife 3 is substantially parallel to the bottom face of the knife holder 2. However, in this embodiment, the clearance 57 in the form of an elongated, substantially triangular tapered shape is formed. In the third embodiment, since the two guide portions 71 and 72 are configured by the rotary roller bodies 73 that rotate about a horizontal axis, when the knife is inserted to the lower face side of the knife holder 2, the spine top portion t of the knife and the guide portions 71 and 72 come into rotational contact, thereby reducing contact scratches to the spine top portion of the knife and enables the knife to be held in a hygienic state.

Further, in the example of FIG. 8, machining is performed on the knife 3 to be inserted. FIG. 7 is a partially-omitted side view illustrating the knife 3 mounted to the device 70 according to the third embodiment illustrated in FIG. 8. In the drawings, the knife 3 illustrated in FIG. 7 includes a recess 81 recessed from the top portion line of the spine m of the knife. The recess 81 functions as a stopper that receives the first guide portion 71 from below when the knife is inserted diagonally forward and upward, or forward, along the magnetic adhesion surface from the lower side relative to the insertion portion 14 of the holder 2. In the embodiment, the shape of the recess 81 is a downward-recessed V-shape, but the recess 18 May be a downward-recessed circular groove or another type of recessed groove. Additionally, when the knife 3 is inserted from the lower face side of the knife holder 2 and approaches the lower face side of the knife holder 2, the knife magnetically adheres to the knife holder and the entire spine top portion of the knife comes into contact at the horizontal tangent of the rotating roller bodies 73. Thus, the knife 3 is held in air. If the knife 3 is pushed further back in this state, the rotating roller bodies 73 slide into the recess 81 of the knife 3, thereby easily preventing further backward insertion. In this state, the elongated, substantially triangular tapered clearance 57 is formed between the top portion t of the peak of the knife and the magnetic adhesion surface WS. Note that, as illustrated in FIG. 8, when the top portion t of the knife is received by the two front and rear rotating roller bodies 73, the diameter of each roller body 73 May be slightly increased or the groove depth of the recess 81 May be made shallower such that the clearance 57 is a thin plate-like clearance having a constant clearance thickness. With this configuration, the user can safely and stably mount and demount the knife to/from the knife holder device 1. Further, this rotational contact reduces damage to the spine top portion of the knife and enables the knife to be held in a hygienic state.

The knife holder device according to the present invention described above is not limited to the embodiments and configurations described above. For example, the knife including the recess 81 can be used with the knife holder device according to the first and second embodiments. Additionally, in the configuration in which the two guide portions are provided on the insertion side and the front side of the knife holder, one of the guide portions may be a vertically semi-split cylindrical engaging piece and the other guide portion may be a rotating roller body. In this case, the shape of the engaging piece is not limited to a vertically semi-split cylindrical shape and may be a triangular shape, a square shape, a polygonal shape, or a deformed column shape. The shape of the permanent magnet does not need to be a flat button shape and may be any shape.

The knife holder device according to the embodiments described above includes a knife holder including magnets attached to the knife holder in a row in one direction, the knife holder being configured to magnetically adhere to a top portion of a spine of a knife when a long side of the knife is oriented horizontally so that the knife holder suspends the entire knife in air; a support body supporting the knife holder at a predetermined height position; and a separating/holding mechanism attached to the knife holder and being configured to hold the knife in air while separating the top portion of the spine of the knife from a magnetic adhesion surface at a position below the magnetic adhesion surface. Thus, since the spine top portion of the knife is held by magnetic adhesion, the knife can be temporarily placed and taken out by an easy insertion operation requiring little force. Additionally, scratches caused by the top portion of the knife coming into contact with the knife holder during the insertion operation are greatly reduced, preventing the growth of bacteria and other germs and enabling the knife to be used in a hygienic manner.

The separating/holding mechanism has a configuration including the guide portion provided at an end portion side of the knife holder, the end portion side being an insertion side at which the knife is inserted into the knife holder, the guide portion being configured to come into contact with the top portion of the spine of the knife at a position at least lower than the magnetic adhesion surface of the knife holder. Thus, the knife can be specifically held in air with the top portion of the spine of the knife separated from the magnetic adhesion surface at a position below the magnetic adhesion surface.

The guide portion has a configuration in which the guide portion is an engaging piece including a portion that comes into contact with the top portion of the spine of the knife at a position lower than the magnetic adhesion surface of the knife holder, or a rotating roller body that rotates about a horizontal axis. Thus, the knife can be attached to the bottom portion of the knife holder or the like and the top portion of the spine of the knife can reliably magnetically adhere to the knife holder at a position below the magnetic adhesion surface of the knife holder so that the knife is supported in air.

The guide portion has a configuration in which at least two of the guide portions are provided at the end portion side of the knife holder being the insertion side at which the knife is inserted into the knife holder and a side in front of the insertion side, respectively, and each of the guide portions comprises a rotating roller body that rotates about a horizontal axis. Thus, only the two rotating roller bodies come into contact with the top portion of the spine of the knife when the knife is mounted, whereby close surface contact can be greatly reduced, scratches due to contact with the spine top portion of the knife can be reduced and hygiene can be increased. Additionally, when the knife is taken out, there is not direct friction between the knife holder and the top portion of the spine of the knife, which greatly reduces the occurrence of scratches or the like due to friction. Further, there is little friction when the knife is mounted and released, meaning that the knife can be inserted and taken out smoothly and the knife can be prevented from accidentally falling, which improves safety.

The knife configured to be magnetically supported by the magnets of the knife holder device described above has a configuration including a body portion of the knife in the vicinity of a bolster of the knife, and a downward-recessed recess formed in the top portion of the spine of the knife, recessed from the top portion line of the spine of the knife and configured to detachably fit with a contact portion of the guide portion. Thus, when the knife is inserted into the insertion portion, the guide portions slide into the recess of the knife to act as a stopper, thereby stopping further backward insertion of the knife with an action requiring little force, and the stop position is automatically determined. With this configuration, the user can stably and safely mount and demount the knife to/from the knife holder device. Further, in a configuration where both the two front and rear guide portions are rotating roller bodies, the knife can be inserted easily and smoothly, and the rotational contact reduces scratches to the spine top portion of the knife and the knife can be held in a hygienic manner.

The knife holder, knife holder device and knife according to the present invention are not limited to the configurations in the embodiments described above, and other embodiments may be used in a range not departing from the gist of the invention described in the scope of the claims.

### Industrial Applicability

The knife holder device and knife according to the present invention can be installed in a kitchen or around a benchtop that is used daily and can be effectively used when cooking food.

### Reference Signs List

1, 60, 70 Knife holder device
2 Knife holder
3 Knife
3A Knife according to first and second examples
3B Knife according to third example
4 Support body
5 Separating/holding mechanism
10 Holder body
11 Recessed portion
12 Thinned portion
14 Insertion portion
15 Thin-plate-like hole
18 Magnet
50 Guide portion
51 Contact portion
61 First guide portion
62 Second guide portion
71 First guide portion
72 Second guide portion
73 Rotating roller body
81 Recess of knife
m Spine
t Top portion
W Bottom wall
WS Magnetic adhesion surface

1. A knife holder device, comprising:
a knife holder including magnets attached to the knife holder in a row in one direction, the knife holder being configured to magnetically adhere to a top portion of a spine of a knife when a long side of the knife is oriented horizontally so that the knife holder suspends the entire knife in air;
a support body supporting the knife holder at a predetermined height position; and
a separating/holding mechanism attached to the knife holder and being configured to hold the knife in air while separating the top portion of the spine of the knife from a magnetic adhesion surface at a position below the magnetic adhesion surface.

2. The knife holder device according to claim 1, wherein
the separating/holding mechanism includes a guide portion provided at an end portion side of the knife holder, the end portion side being an insertion side at which the knife is inserted into the knife holder, the guide portion being configured to come into contact with the top portion of the spine of the knife at a position at least lower than the magnetic adhesion surface of the knife holder.

3. The knife holder device according to claim 2, wherein
the guide portion comprises an engaging piece including a portion that comes into contact with the top portion of the spine of the knife at a position lower than the magnetic adhesion surface of the knife holder, or a rotating roller body that rotates about a horizontal axis.

4. The knife holder device according to claim 2, wherein
at least two of the guide portions are provided at the end portion side of the knife holder being the insertion side at which the knife is inserted into the knife holder and a side in front of the insertion side, respectively, and
each of the guide portions comprises the rotating roller body that rotates about a horizontal axis.

5. A knife configured to be magnetically supported by the magnets of the knife holder device according to claim 1, the knife comprising:
a body portion of the knife in the vicinity of a bolster of the knife, and
a downward-recessed recess formed in the top portion of the spine of the knife, recessed from the top portion line of the spine of the knife and configured to detachably fit with a contact portion of the guide portion.
